(19) United States
(12) Patent Application Publication
(10) Pub. No.: US 2007/0139330 A1
(43) Pub. Date: Jun. 21, 2007

(54) Display units, display devices, and repair methods for convering a bright dot to a dark dot in same

(75) Inventors: I-Wei Wu, Hsinchu (TW); Chien-Yi Hsu, Hsinchu City (TW); Yi-Hsing Lee, Keelung City (TW)

Correspondence Address: LIU & LIU, 444 S. FLOWER STREET, SUITE 1750, LOS ANGELES, CA, 90071, US

(73) Assignee: TOPPOLY OPTOELECTRONICS CORP.

(21) Appl. No.: 11/313,118

(22) Filed: Dec. 19, 2005

(51) Int. Cl. G09G 3/36

(52) U.S. Cl. 345/90

(57) ABSTRACT

A display unit for a display panel. The display unit comprises a switch unit, a liquid crystal capacitance, and a storage capacitor. The switch unit has a control terminal coupled to a scan line, an input terminal coupled to a data line, and an output terminal coupled to a pixel electrode. The liquid crystal capacitance is coupled between the pixel electrode and a common electrode receiving a common-voltage signal. The storage capacitor is coupled to the pixel electrode and a reference electrode receiving a low-gate signal. The level of the common-voltage signal is different from that of the low-gate signal.

### BACKGROUND

The present invention relates to a display unit, and in particular to a repair method for a bright dot in a display unit.

FIG. 1a is a schematic diagram of a conventional liquid crystal display (LCD) panel. As shown in FIG. 1a, the LCD panel 1 comprises a data driver 10, a scan driver 11, and a display array 12. The data driver 10 controls a plurality of data lines D₁ to Dₘ, and the scan driver 11 controls a plurality of scan lines G₁ to Gₙ. The display array 12 is formed by intersecting data lines D₁ to Dₘ and scan lines G₁ to Gₙ. The interlaced data line Dₘ and scan line Gₙ correspond to a display unit, for example, the interlaced data line D₁ and scan line G₁ correspond to a display unit 100. For each display unit, the equivalent circuit of the display unit 100 comprises a thin film transistor (TFT) T10, a storage capacitor Cs10, and a liquid crystal capacitance Clc10. The TFT T10 has a gate terminal coupled to the scan line G₁, a drain terminal coupled to the data line D₁, and a source terminal coupled to a pixel electrode PE. The storage capacitor Cs10 is coupled between the pixel electrode PE and a reference electrode RE and stores voltage of a video signal. The liquid crystal capacitance Clc10 is coupled between the pixel electrode PE and a common electrode CE. In conventional LCD processes, the reference electrode RE and the common electrode CE are coupled and both receive a common voltage Vcom.

FIG. 1b is a schematic diagram of voltage coupled to scan lines G₁ to Gₙ and common voltage coupled to the common electrodes. Referring to FIGS. 1a and 1b, the scan driver 11 sequentially outputs scan signals to scan lines G₁ to Gₙ according to a scan control signal. When receiving a scan signal with a high-gate voltage Vhi, a scan line corresponding to a row turns on the TFTs corresponding to the row, while other TFTs corresponding to other rows are turned off by other scan lines receiving a low-gate voltage Vlo. When the TFTs corresponding to a row are all turned on, the data driver 10 outputs corresponding video signals with gray scale values to m display units corresponding to the row through the data lines D₁ to Dₘ according to image data prepared for but not yet displayed. Each time when the scan driver 11 finishes scanning all n rows, the display of a single frame is complete. Therefore, the object of displaying images is achieved by repeatedly scanning scan lines and outputting video signals.

FIG. 2 is a schematic sectional view of the structure of the display unit 100. A color filter CF is formed under an upper substrate 20, and the common electrode CE is formed under the color filter CF. The TFT T10 and the reference electrode RE are formed on a lower substrate 21. A dielectric layer DL20 is formed over the TFT T10 and the reference electrode RE. The pixel electrode PE is formed on the dielectric layer DL20 and electrically connected with the TFT T10 through a via hole H20. Referring to FIG. 2, the liquid crystal capacitance Clc10 is formed between the common electrode CE and the pixel electrode PE, and the storage capacitor Cs10 is formed between the pixel electrode PE and the reference electrode RE.

In practice, leakage of the storage capacitor Cs10 may be induced by impurities between the pixel electrode PE and the reference electrode RE, including a short circuit therebetween. Accordingly, the pixel electrode PE and the reference electrode RE have the same potential, which is the common voltage Vcom. Thus, there is no voltage difference between the pixel electrode PE and the common electrode CE, and liquid crystal molecules within the liquid crystal capacitance Clc10 are not twisted. Thus, bright dots appear when the LCD panel is in a normally white mode, resulting in decreased image quality of the LCD.

### SUMMARY

The present invention is directed to a display unit that is configured to reduce bright dot effect in a display panel. According to one aspect of the present invention, the display unit comprises parallel coupled liquid crystal capacitance and storage capacitor, which are biased at different voltage potentials. In this configuration, in the event of a short in the storage capacitor, the liquid crystal capacitance remains biased to reduce displaying a bright dot in the display panel.

In one embodiment, the storage capacitor and the liquid crystal capacitance are commonly coupled at one end to the pixel electrode, and at the other end separately to different voltages. In a further embodiment, the other end of the liquid crystal capacitance is couple to a common voltage, and the other end of the storage capacitor is connector to a low-gate voltage, wherein the common voltage and the low-gate voltage are different.

In another aspect of the present invention, the display unit provides an effective circuit structure that facilitates repair of the circuit to reduce bright dot effect. In one embodiment, the display unit includes a transistor switch (e.g., a TFT) coupled to scan and data lines, and to parallel coupled liquid crystal capacitance and storage capacitor at different voltage potentials. In the event of a short between the drain and source of the transistor, to repair the display unit to reduce bright dot, the source or drain is decoupled from the rest of the circuit, and the storage capacitor is shorted, so as to apply a voltage potential difference across the liquid crystal capacitance.

An exemplary embodiment of a display unit is applied in a display panel having a display array formed by at least one data line and at least one scan line and comprises a switch unit, a liquid crystal capacitance, and a storage capacitor. The switch unit has a control terminal coupled to the scan line, an input terminal coupled to the data line, and an output terminal coupled to a pixel electrode. The liquid crystal capacitance is coupled between the pixel electrode and a common electrode receiving a common-voltage signal. The storage capacitor is coupled to the pixel electrode and a reference electrode receiving a low-gate signal. The voltage level of the common-voltage signal is different from that of the low-gate signal.

Repair Methods for converting a bright dot to a dark dot in a display unit are provided. The display unit comprises a switch unit having a control terminal coupled to a scan line, an input terminal coupled to a data line, and an output terminal coupled to a pixel electrode, a liquid crystal capacitance coupled between the pixel electrode and a common electrode, and a storage capacitor coupled to the pixel electrode and a reference electrode. An exemplary embodiment of a method comprises the steps of: disconnecting the input terminal of the switch unit from the data line; connecting the pixel electrode to the reference electrode; wherein, a voltage level on the common electrode and a voltage level on the reference electrode are different.

### DESCRIPTION OF THE DRAWINGS

Display panels will become more fully understood from the detailed description given hereinbelow and the accompanying drawings, given by way of illustration only and thus not intended to be limitative of the invention.

FIG. 1a is a schematic diagram of a conventional LCD panel.

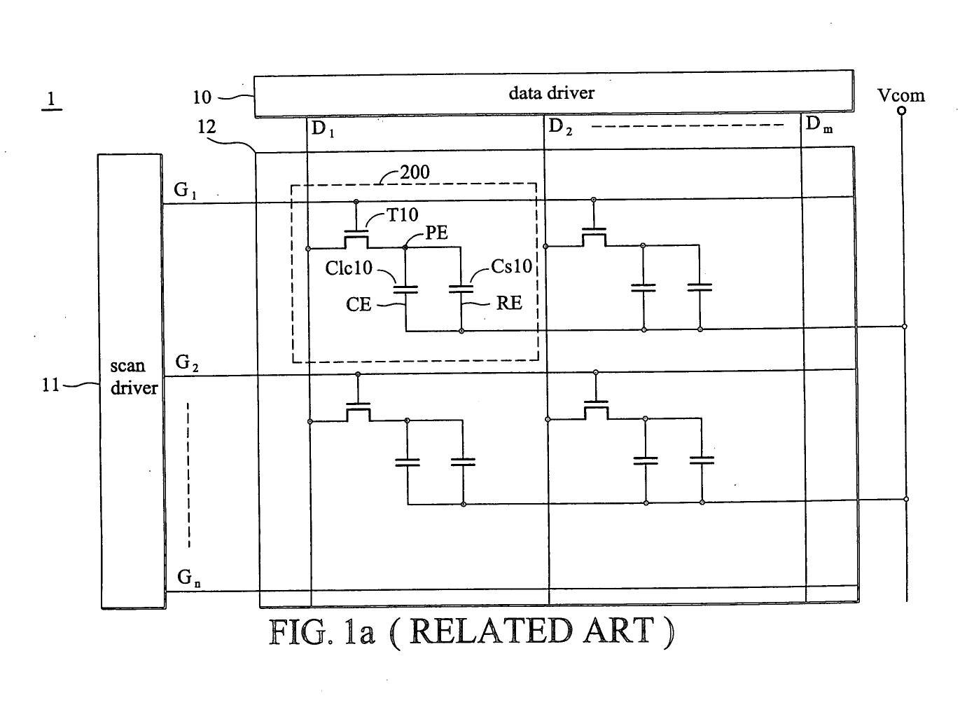

FIG. 1b is a schematic diagram of voltage coupled to scan lines G₁ to Gₙ and common voltage coupled to the common electrodes in the conventional LCD of FIG. 1a.

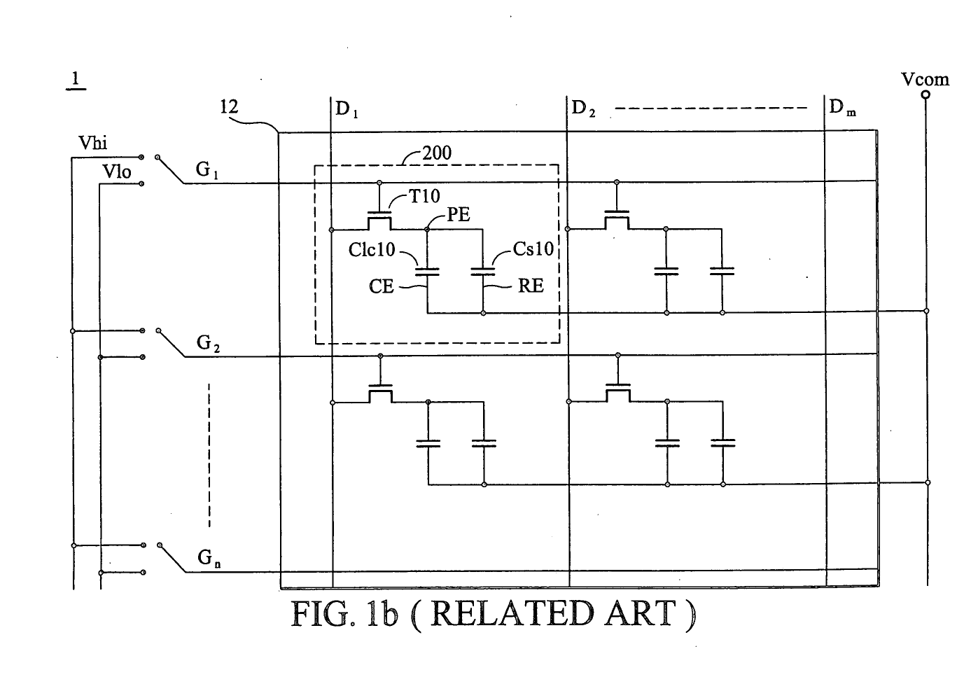

FIG. 2 is a schematic sectional view of the display unit 100 in accordance with one embodiment of the present invention.

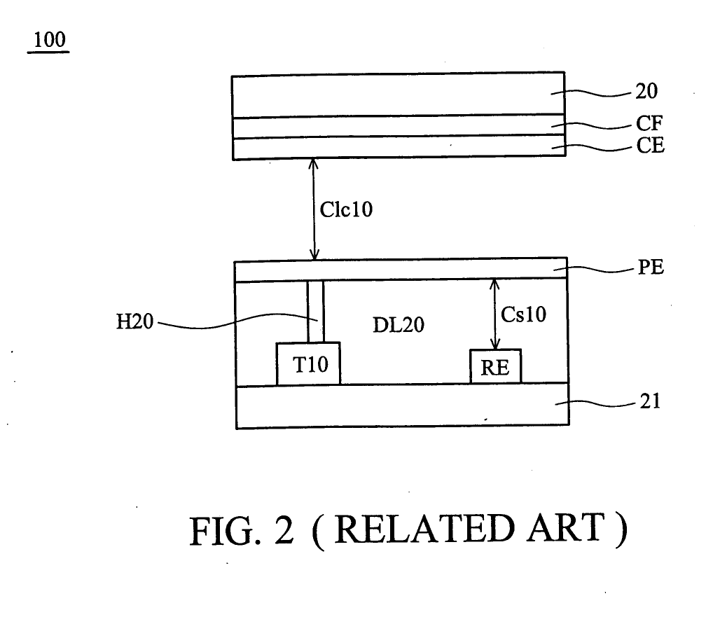

FIG. 3a depicts an embodiment of a display panel in accordance with the present invention.

FIG. 3b is a schematic diagram of voltage coupled to scan lines G₁ to Gₙ and common voltage coupled to the common electrodes in the display panel of FIG. 3a.

FIG. 4 is a flow chart of an embodiment of a repair method in accordance with the present invention, for reducing a bright dot in a display unit.

FIG. 5 is a schematic diagram of a display device deploying display panel device disclosed in FIG. 3a.

FIG. 6 is a schematic diagram of an electronic device deploying display device disclosed in FIG. 5.

### DETAILED DESCRIPTION

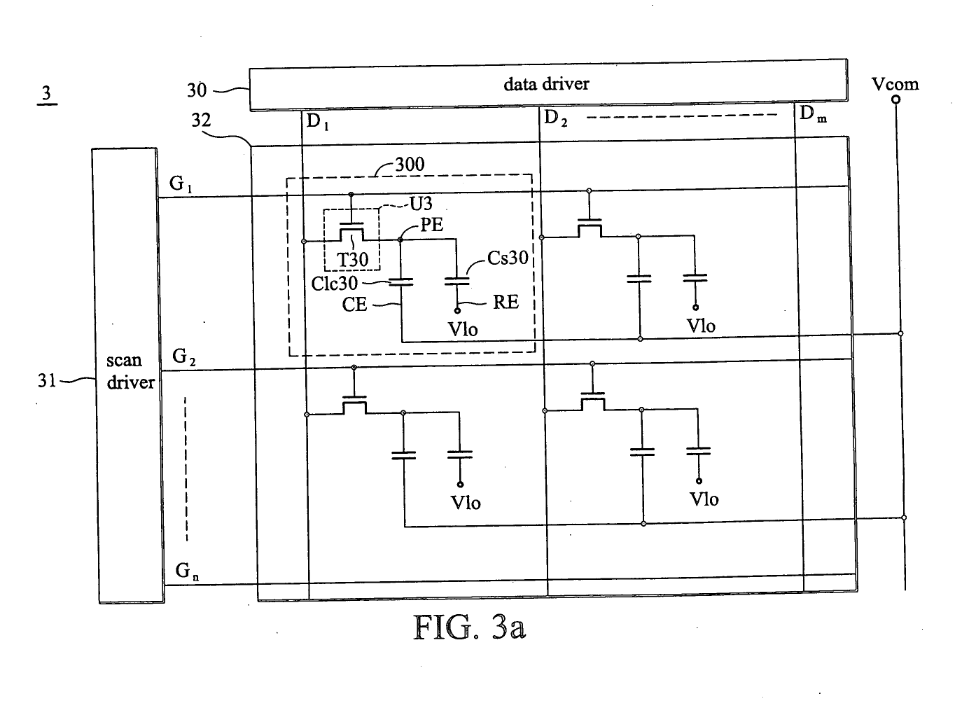

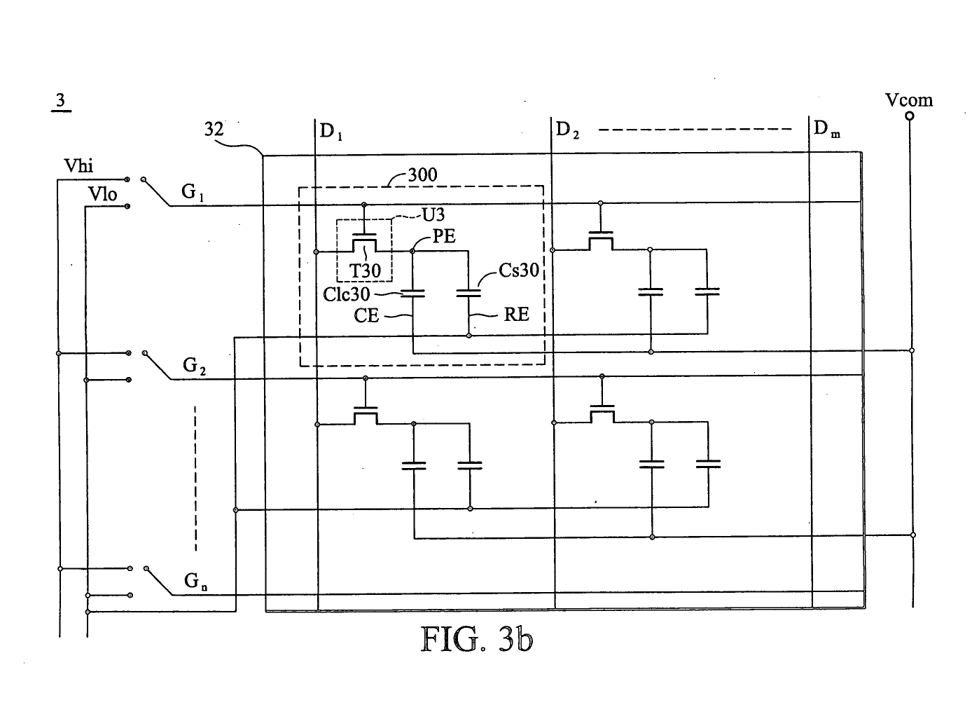

Display panels are provided. In some embodiments, as shown in FIG. 3a, a display panel 3 is in a normally white mode and comprises a data driver 30, a scan driver 31, and a display array 32. The data driver 30 controls a plurality of data lines D₁ to Dₘ, and the scan driver 31 controls a plurality of scan lines G₁ to Gₙ. The display array 32 is formed by intersecting data lines D₁ to Dₘ and scan lines G₁ to Gₙ. The interlaced data line Dₘ and scan line Gₙ correspond to a display unit, for example, interlaced data line D₁ and scan line G₁ correspond to a display unit 300. For each display unit, the equivalent circuit of the display unit 300 comprises a switch unit U3, a storage capacitor Cs30, and a liquid crystal capacitance Clc30. In the embodiment of FIG. 3a, the switch unit U3 can be a thin film transistor (TFT) T30, such as an N-type TFT or a P-type TFT. Gate, drain, and source terminals of the TFT T30 respectively serve as control, input, and output terminals of the switch unit U3. The gate terminal of the TFT T30 is coupled the scan line G₁, the drain terminal thereof is coupled to the data line D₁, and the source terminal thereof is coupled to a pixel electrode PE. The storage capacitor Cs30 is coupled between the pixel electrode PE and a reference electrode RE, and the liquid crystal capacitance Clc30 is coupled between the pixel electrode PE and a common electrode CE.

FIG. 3b is a schematic diagram of voltage coupled to scan lines G₁ to Gₙ and common voltage coupled to the common electrodes in the display panel of FIG. 3a. Referring to FIGS. 3a and 3b, in detail, the display unit 300 is given as an example. The scan driver 31 outputs a scan signal with a high-gate voltage Vhi to scan line G₁ according to a scan control signal. When receiving the scan signal, the scan line G₁ turns on the TFT T30 within the display unit 300. When the TFT T30 is turned on, the data driver 30 outputs a corresponding video signal with a data voltage Vdata to the display unit 300 through the data line D₁. At the same time, a voltage level of the pixel electrode PE is equal to the data voltage Vdata. Conversely, when the scan driver 31 outputs the scan signal with a low-gate voltage Vlo to the scan line G₁ according to the scan control signal, the scan line G₁ turns off the TFT T30.

Accordingly to one embodiment of the present invention, the common electrode CE receives a common-voltage signal Scom with a common voltage Vcom and the reference electrode RE receives a low-gate signal Slo with the low-gate voltage Vlo. Levels of the low-gate voltage Vlo and the common voltage Vcom are different. In this embodiment, the level of the low-gate voltages is lower than that of the common voltage Vcom. When a short circuit is produced between the pixel electrode PE and the reference electrode RE due to impurities therebetween caused during the process, a potential of the pixel electrode PE is equal to the voltage level of the reference electrode RE, the low-gate voltage Vlo. There is still a voltage difference between the pixel electrode PE and the common electrode CE, and liquid crystal molecules within the liquid crystal capacitance Clc30 can still twist according to the voltage difference. Thus, when the process of display units causes a short circuit, the bright dots are reduced, improving image quality.

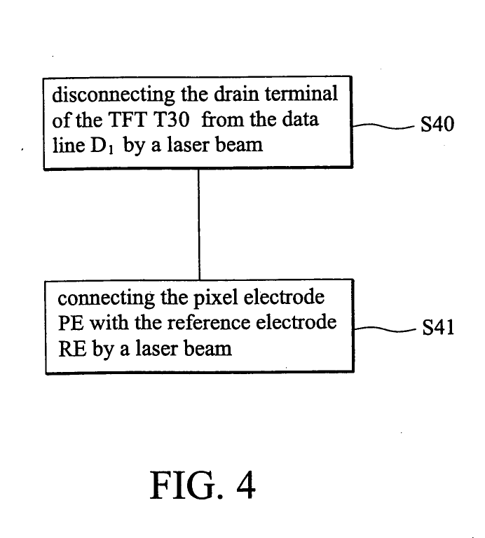

In manufacturing process of a display unit 300, a short circuit may occur between the drain and source terminals of the TFT T30, making the TFT T30 in always on state, and a bright dot would appear on the display unit 300. FIG. 4 is a flow diagram of an embodiment of a repair method for converting a bright dot to a dark dot in a display unit of a display panel. Referring to FIGS. 3a and 4, when a bright dot appears in the display unit 300 due to the short circuit between the drain and source terminals of the TFT T30, the drain terminal of the TFT T30 is disconnected from the data line D₁ by a laser beam (step S40), so that, a video signal on the data line D₁ can not be transmitted to the display unit 300. Then, the pixel electrode PE is configured to connect with the reference electrode RE by a laser beam (step S41). In other words, the voltage levels of the pixel electrode PE and the reference electrode RE are the same. Thus, liquid crystal molecules within the liquid crystal capacitance Clc30 can twist according to a voltage difference between the pixel electrode PE and the common electrode CE. Thus, the bright dot becomes less bright or dark.

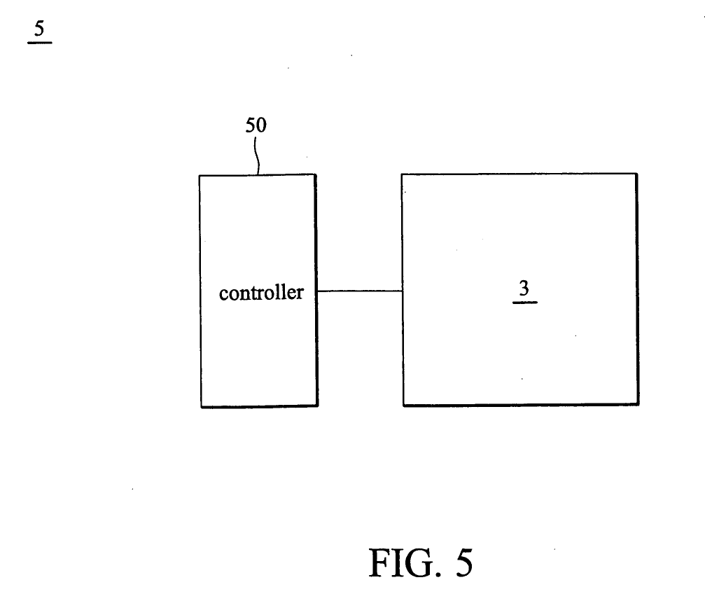

FIG. 5 schematically shows a display device 5 deploying display panel 3 disclosed. Generally, the display device 5 includes a controller 50, and the display panel 3 shown in FIG. 3a, etc. The controller 50 is operatively coupled to the display panel 3 and provides control signals, such as clock signals, start pulses, or image data, etc, to the display panel 3.

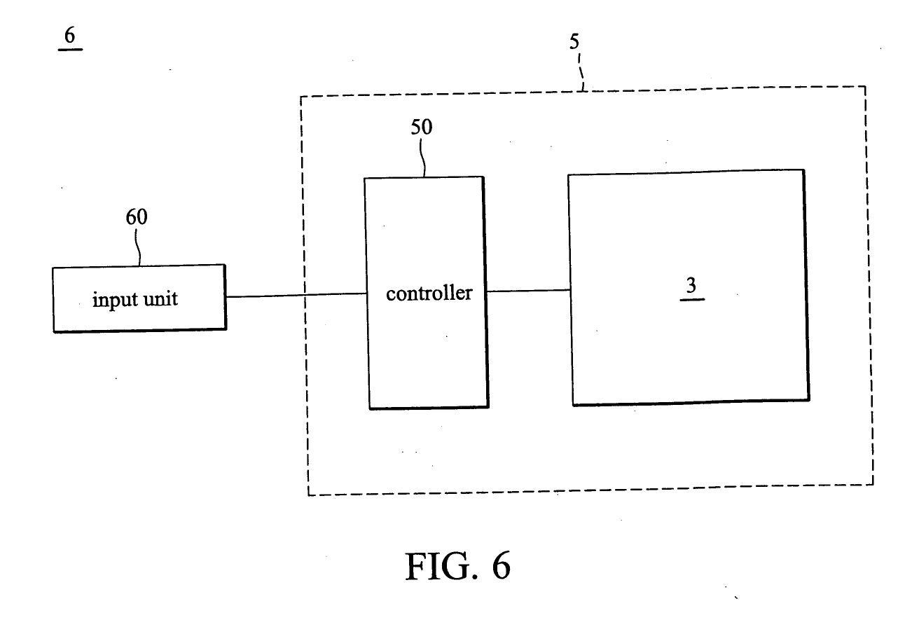

FIG. 6 schematically shows an electronic device 6 deploying display device 5 disclosed. The electronic device 6 may be a portable device such as a PDA, notebook computer, tablet computer, cellular phone, or a display monitor device, etc. Generally, the electronic device 6 comprises an input unit 60 and the display device 5 shown in FIG. 5, etc. Further, the input unit 60 is operatively coupled to the display device 5 and provides input signals (e.g., image signal) to the display device 5. The controller 50 of the display device 5 provides the control signals to the display panel 3 according to the input signals.

While the present invention has been described in terms of various embodiments, it is to be understood that the present invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A display unit for a display panel having a display array formed by at least one data line and at least one scan line, comprising:
a switch unit having a control terminal coupled to the scan line, an input terminal coupled to the data line, and an output terminal coupled to a pixel electrode;
a liquid crystal capacitance coupled between the pixel electrode and a common electrode receiving a common-voltage signal; and
a storage capacitor coupled to the pixel electrode and a reference electrode receiving a low-gate signal;
wherein a voltage level of the common-voltage signal is different from that of the low-gate signal.

2. The display unit as claimed in claim 1, wherein the voltage level of the low-gate signal is lower than that of the common-voltage signal.

3. The display unit as claimed in claim 1, wherein the scan line turns on the switch unit with a first voltage and turns off that with a second voltage.

4. The display unit as claimed in claim 3, wherein the level of the low-gate signal is equal to the second voltage.

5. The display unit as claimed in claim 4, wherein the switch unit is an N-type transistor or a P-type transistor.

6. A repair method for converting a bright dot to a dark dot in a display unit comprising a switch unit having a control terminal coupled to a scan line, an input terminal coupled to a data line, and an output terminal coupled to a pixel electrode, a liquid crystal capacitance coupled between the pixel electrode and a common electrode, and a storage capacitor coupled to the pixel electrode and a reference electrode, the method comprising:
disconnecting the input terminal of the switch unit from the data line or output terminal from the switch unit; and
connecting the pixel electrode and the reference electrode together;
wherein, a voltage level on the common electrode and a voltage level on the reference electrode are different.

7. The method as claimed in claim 6, wherein the voltage level of the reference electrode is lower than the voltage level of the common electrode.

8. The method as claimed in claim 6, wherein the scan line turns on the switch unit with a first voltage and turns off that with a second voltage.

9. The method as claimed in claim 8, wherein the voltage level on the reference is equal to the second voltage.

10. The method as claimed in claim 9, wherein the switch unit is an N-type transistor or a P-type transistor.

11. A display panel, comprising:
a display array formed by a plurality of data lines and a plurality of scan lines and comprising a plurality of display units as claimed in claim 1, wherein the scan lines are interlaced with the data lines.;
a data driver controlling the data lines; and
a scan driver controlling the scan lines.

12. A display device, comprising:
a display panel as claimed in claim 11; and
a controller, wherein the controller is operatively coupled to the display panel.

13. An electronic device, comprising:
a display device as claimed in claim 12; and
an input unit, wherein the input unit is operatively coupled to the display device.

14. The electronic device as claimed in claim 13, wherein the electronic device is a PDA, a display monitor, a notebook computer, a tablet computer, or a cellular phone.

15. A display unit for a liquid crystal display panel, comprising:
a liquid crystal capacitance biased at a first voltage potential;
a storage capacitor operatively coupled in parallel to the liquid crystal capacitance, and biased at a second voltage potential, wherein the first and second voltage potentials are different; and
a switch unit commonly coupled to the parallel coupled liquid crystal capacitance and storage capacitor.

16. The display unit as in claim 15, wherein the storage capacitor and the liquid crystal capacitance are commonly coupled at one end to the switch unit, and at the other end separately to different voltages.

17. The display unit as in claim 15, further comprising a data line and a scan line, wherein the switch unit is also operatively coupled to the scan line and data line.

18. The display unit as in claim 17, wherein the switch unit comprises a transistor having a source and drain, and wherein in the event of a short between the drain and source of the transistor, the source or drain is decoupled from the rest of the circuit, and the storage capacitor is shorted, so as to maintain a voltage potential difference across the liquid crystal capacitance.

19. The display unit as in claim 18, wherein the voltage difference is difference between the first and second voltage potentials.

20. The display unit as in claim 19, wherein the first voltage potential is higher than the second voltage potential.
